(19) United States
(12) Patent Application Publication
(10) Pub. No.: US 2023/0264369 A1
(43) Pub. Date: Aug. 24, 2023

(54) GRIPPER FOR BEVERAGE CANS, GRIPPER HEAD, AND METHOD FOR RECEIVING AT LEAST ONE BEVERAGE CAN

(71) Applicant: Krones Aktiengesellschaft, Neutraubling (DE)

(72) Inventors: Thomas STADLER, Kolbermoor (DE); Stephan WITTMANN, Siegsdorf (DE); Herbert SPINDLER, Niedermoosen (DE)

(21) Appl. No.: 18/010,120

(22) PCT Filed: Feb. 4, 2021
(86) PCT No.: PCT/EP2021/052723

§ 371 Date: Dec. 13, 2022

(30) Foreign Application Priority Data
Jul. 21, 2020 (DE) 10 2020 119 228.2

(51) Int. Cl. B25J 15/00; B25J 15/08; B25J 15/02

(52) U.S. Cl. CPC B25J 15/0033; B25J 15/0004; B25J 15/0052; B25J 15/0206; B25J 15/086

(57) ABSTRACT

Disclosed is a gripper (1) for beverage cans (20). The gripper (1) comprises at least one gripping device (6) used to grip a particular beverage can (20) from underneath the top seam (5) in a form-fitting manner in the region of a top seam (5), which top seam (5) is formed by a particular beverage can (20). The gripper (1) comprises at least one centering device (30), by which at least one centering device (30) aligns the particular beverage can (20) into a defined alignment, where the at least one gripping device (6) is able to grip a particular beverage can (20) from underneath in a form-fitting manner in the region of its top seam (5).

### CLAIM OF PRIORITY

The present application claims priority to International Application PCT/EP2021/052723 filed Feb. 4, 2021, which in turn claims priority to German Application DE 10 2020 119 228.2 filed Jul. 21, 2020, which are incorporated by reference.

### FIELD OF THE INVENTION

The present invention relates to a gripper for beverage cans and to a method used to receive at least one beverage can.

### BACKGROUND OF THE INVENTION

Besides bottles and beverage cartons, beverage cans are among the most important commercial packaging types for beverages. In addition, they can serve as drinking vessels as well. Beverage cans are primarily used for carbonated drinks, such as canned beer and soft drinks, for example, colas, all kinds of lemonades, and energy drinks. For drinking, beverage cans are typically opened by a pull tab arranged in the lid.

Currently used beverage cans usually consist, among others, of a one-piece, cylindrical container made of aluminum or tinplate with a lid of aluminum fixed to it by a folded seam (sometimes called a top seam), the lid having an oval score line and a metal tab riveted to it, which functions as a “built-in can opener” by pressing the scored oval into the can through leverage when being lifted and thus forming a spout or drink opening. In the region of the can body below the lid, the diameter of the can normally tapers and thereby forms a neck. The lid therefore usually has a smaller outer diameter than the cylindrical body of the can.

There is a variety of different packaging types for processing, arranging, grouping, and packaging articles, such as beverage containers in the form of cans, for example, the assembly of articles or containers into portable, relatively handy pack units, which can generally be regarded as packaging units. Various possibilities are also known for assembling individual cans into larger packs. Beverage containers, for example, are mostly gathered together by shrink films and packaged into packs of four, six, or more containers. It is usually inevitable to produce packs, because packs are the most common type of sales units or packaging units for beverage containers, in particular for cans made of metal or plastic or for bottles made of PET plastic material. Some packs are further gathered together and/or assembled in layers and placed on pallets for transport purposes.

Another known variant involves the use of so-called top gripping type cartons to gather together via their neck regions a plurality of beverage containers, for example, in particular bottles or cans. The patent document EP 1 075 419 B1 describes a packaging machine used to position such top gripping type cartons. In this context, the articles are arranged in a crate, and the gripping type carton is positioned from above onto the at least one article arranged in the crate. In particular, there is a plurality of articles arranged in the crate, and subgroups are formed by positioning a smaller number of top gripping type cartons, with the subgroups each gathering together a part of the articles arranged in the crate.

Many different sizes of cans are meanwhile commonly used and available. While cans with a capacity of 0.33 or 0.5 liters are customarily available, there are also cans with 0.15, 0.25, 0.355 liters, or with other capacities.

Moreover, there are different shapes of cans that are known. While the lids of standard cans have a significantly smaller diameter than the cylinders of the cans as such, the cylinder diameters and the lid diameters of so-called slim cans or sleek cans are largely or approximately the same.

In order to arrange an outer packaging, the cans are assembled in groups, with the arrangement and number of the cans assembled in a group being defined according to the packaging unit to be produced. The standard cans assembled in a group are, in particular, arranged in a contiguous manner and touch each other at the contact surfaces. When transferring the can assembly into a corresponding packaging module, the standard cans are each suctioned and lifted by vacuum cups at their can edges and/or can lids. For this purpose, the vacuum cup has to have a diameter in the suction area that is larger than the can edge, and at the same time, the diameter has to be smaller than the maximum outer diameter of the standard can, so that the arrangement of the directly contiguous standard cans will not become misaligned.

Hitherto know gripping devices, which are able to receive beverage cans and move them along a transfer path for further handling or for packaging, have a complex structure. It can also not be excluded with certainty for the above-described seizing by vacuum cups that beverage cans become inadvertently disengaged from the gripping device. This may in particular be the case when a position of beverage cans does not correspond to an expected target position upon being received. This may happen, for example, if individual beverage cans inadvertently shift prior to being received, or if their particular positions are changed by other mechanical causes. In order to be able to move the beverage cans into the seizing range of a gripping device in an exact arrangement, guide rails are therefore frequently necessary in practice. It would be desirable to have packaging apparatuses designed with a simple and compact structure, which would make it possible to dispense with such guide rails.

It is therefore one object of the invention to provide a gripper for beverage cans that is characterized by a simple structure and that is able to receive and handle beverage cans with high reliability. A further object can be seen in providing a corresponding method that is easy to implement and that makes it possible to receive and handle beverage cans with high reliability.

The above tasks are fulfilled by the objects comprising the features in the independent claims. Embodiments of the invention are described in the dependent claims.

### SUMMARY OF THE INVENTION

The invention relates to a gripper for beverage cans. In various embodiments, the gripper may be designed to receive exactly one beverage can. The gripper, which is thus generally suitable to receive beverage cans, may in practice also be provided to receive cans with other contents, for example food. The use of the gripper is therefore not limited to beverage cans.

The gripper comprises at least one gripping device used to grip a particular beverage can from underneath the top seam in a form-fitting manner in the region of a top seam, with the top seam being formed by a particular beverage can, such that an under edge or under side of the top seam rests on or is at least partially supported by the gripping device when the beverage can is gripped. The at least one gripping device may be formed by at least one lever, which at least one lever can be rotated about a certain pivot point in order for the gripping device to receive and/or release a particular beverage can. Alternatively or additionally, the at least one lever may be designed to be reversibly elastically deformable. It is conceivable that the at least one gripping device or that the at least one lever is at least partially made of plastic.

The gripper further comprises at least one centering device, by which at least one centering device the particular beverage can is bringable into a defined alignment, in which defined alignment the at least one gripping device is able to grip a particular beverage can from underneath the top seam, in a form-fitting manner.

If required, it is possible for the gripper to comprise at least one tappet, which at least one tappet interacts with the at least one gripping device such that it is possible to undo a particular form-fitting grip of the at least one gripping device by a linear actuating movement of the at least one tappet. Where appropriate, one end section of the at least one gripping device may be held by the at least one tappet, or the at least one gripping device may be mounted in the at least one tappet. It is in particular possible that an end section of the at least one gripping device is held by the at least one tappet in a form-fitting and/or clamping manner and/or is mounted in the at least one tappet in a form-fitting and/or clamping manner.

Alternatively or additionally, it is possible that the at least one tappet interacts with the at least one gripping device such that the at least one gripping device is able to apply a clamping force to a beverage can by a linear actuating movement of the at least one tappet in order to hold the particular beverage can in the region of the particular top seam.

It is moreover conceivable that the at least one tappet interacts with the at least one gripping device such that it is possible for the clamping force applied in order to hold a particular beverage can in the region of the particular top seam to be undone by a further actuating movement of the at least one tappet, with the further actuating movement preferably running in opposite direction.

It is also possible for the gripper to comprise a plurality of gripping devices, with a common tappet being assigned to the plurality of gripping devices, and with the common tappet interacting with the plurality of gripping devices such that it is possible for a particular form-fitting grip of the plurality of gripping devices in the region of the top seam to be undone by a linear actuating movement of the common tappet. The plurality of gripping devices may face away radially from the common tappet or project in radial direction from the common tappet.

Alternatively or additionally, it is possible for the gripper to comprise a plurality of gripping devices, with a common tappet being assigned to the plurality of gripping devices, and with the common tappet interacting with the plurality of gripping devices such that the plurality of gripping devices are able to apply a clamping force to the particular beverage can by a linear actuating movement of the common tappet in order to hold the particular beverage can in the region of the particular top seam.

It is also possible that the at least one tappet or the common tappet forms a thread, which communicates with a corresponding mating thread of the gripper such that the at least one tappet or the common tappet is able to perform a particular linear actuating movement by a rotary movement preferably about its longitudinal axis. Alternatively or additionally, it is possible that the at least one tappet or the common tappet is pneumatically controllable to perform a particular linear actuating movement. Where appropriate, the mating thread of the gripper may be provided by a mounting plate of the gripper and/or by a ball joint of the gripper, which ball joint will be described below.

It is moreover possible for the gripper to comprise at least one return spring, which at least one return spring is able to apply spring force to the tappet or the common tappet in order to return the tappet into a starting position after the performed linear actuating movement. Alternatively or additionally, it is possible that the at least one return spring is able to press the at least one gripping device by force application against the particular beverage can in the region of the top seam.

It is conceivable that the at least one gripping device used to grip the beverage can from underneath the top seam in a form-fitting manner in the region of the top seam comprises at least one insert designed as a hook, which at least one insert designed as a hook is designed as a replaceable component of the at least one gripping device. The at least one insert designed as a hook can be made of steel, aluminum and/or plastic, as the case may be.

Furthermore, the gripper may comprise at least one torsion spring, with the at least one gripper being in contact with the at least one torsion spring, and with the at least one gripping device being held in its position by the at least one torsion spring while the gripping device grips a particular beverage can, and with the form-fitting grip of the at least one gripping device being undoable by spring-elastic movement of the at least one gripping device against the spring force of the at least one torsion spring. Various embodiments are possible in which each gripping device of the plurality of gripping devices has two torsion springs assigned to it, which connect to the particular gripping device on opposite sides or which are in contact with the particular gripping device on opposite sides.

Where appropriate, the gripper may comprise a ball joint, by which ball joint the at least one gripping device and/or the at least one centering device and/or the at least one tappet or the common tappet are swivel-mounted. In this context it is conceivable that the gripper has a mounting plate and a formed part. The formed part can form the at least one centering device. Furthermore, the formed part and the mounting plate together can form the ball joint. It is moreover conceivable for various embodiments that the formed part can be shifted relative to the mounting plate in axial direction or in Z direction.

It is also possible for the gripper to comprise at least one spring, which is preferably formed by a plurality of leaf springs, and which at least one spring provides a restoring force in a swivel movement of the ball joint for the at least one gripping device and/or for the at least one centering device and/or for the at least one tappet or for the common tappet. The at least one spring, which is preferably formed by a plurality of leaf springs, can be in contact with the formed part already described above as well as with the mounting plate already described above.

The invention moreover relates to a gripper head for a plurality of beverage cans, which plurality of beverage cans stand contiguous to each other. The gripper head comprises at least two grippers according to at least one exemplary embodiment of the above description, with a particular gripper being designed to grip a particular beverage can or a plurality of beverage cans. A particular gripper of the at least two grippers may form a particular mounting plate, with the mounting plate s of the at least two grippers abutting flush against each other. The number of the grippers of the gripper head and the number of beverage cans to be received in each instance may be corresponding. In practice, a gripper head may have exactly six grippers or exactly eight grippers, for example.

It is provided for the gripper head that the at least one centering device of the particular gripper is positioned such that the at least one centering device comes into surface contact with an outer body surface in at least one defined region of a particular beverage can when receiving the particular beverage can, which at least one defined region is positioned offset along the circumference of the particular beverage can relative to at least one contact region in which the beverage can is contiguous to at least one other beverage can.

The gripper head may thus be designed to receive a plurality of beverage cans, which plurality of beverage cans are each formed by a plurality of contiguous slimline cans or sleek cans.

The invention moreover relates to a method used to receive at least one beverage can by at least one gripper. Features that have already been described above regarding various embodiments of the gripper or the gripper head can likewise be provided for the embodiments of the method described below, and they are therefore not repeatedly mentioned.

Features described regarding the embodiments of the method can likewise be provided for embodiments of the gripper or gripper head already described above. Where appropriate, the gripper or gripper head can be designed to implement the below described embodiments of the method according to the invention.

The method provides that, in order to receive the at least one beverage can, at least one gripping device, which is designed as a component of the at least one gripper, grips the at least one beverage can from underneath the top seam in a form-fitting manner in the region of a particular top seam, which particular top seam is formed by the particular beverage can.

It is provided that the at least one beverage can is brought into a defined alignment by at least one centering device, which is designed as a component of the at least one gripper, in which defined alignment the at least one gripping device of the at least one gripper is able to grip a particular beverage can from underneath the top seam in a form-fitting manner in the region of the particular top seam.

In this context it is possible that the gripper is positioned onto the particular at least one beverage can in a direction coming from above, with the at least one centering device, which is designed as a part of the at least one gripper, coming into surface contact with the at least one beverage can, and in the process bringing the at least one beverage can into a defined alignment, in which defined alignment the at least one gripping device of the at least one gripper is able to grip a particular beverage can from underneath the top seam in a form-fitting manner in the region of the particular top seam of the beverage can.

It is possible that the at least one gripper has at least one tappet, which at least one tappet performs a linear actuating movement, with the result that the form-fitting grip of the at least one gripping device is undone.

It is further possible that the at least one gripper has at least one tappet, which at least one tappet performs a linear actuating movement, with the result that a clamping force is applied to a particular beverage can by the at least one gripping device in order for the at least one gripping device to hold the particular beverage can.

It is also possible that the at least one gripper has at least one tappet, which at least one tappet performs a linear actuating movement, with the result that a clamping force applied up to then onto the particular beverage can by the at least one gripping device in order for the at least one gripping device to hold the particular beverage can is undone.

It is also possible that one gripper or a plurality of grippers each have a plurality of gripping devices, with a common tappet being assigned to the plurality of gripping devices of the particular gripper, which common tappet performs a linear actuating movement, with the result that the form-fitting grips by the plurality of gripping devices are undone simultaneously or at least approximately simultaneously.

It is conceivable that one gripper or a plurality of grippers each have a plurality of gripping devices, with a common tappet being assigned to the plurality of gripping devices of the particular gripper, which common tappet performs a linear actuating movement, with the result that the plurality of gripping devices apply a clamping force to a particular beverage can simultaneously or at least approximately simultaneously in order to hold the particular beverage can.

It is further conceivable that one gripper or a plurality of grippers each have a plurality of gripping devices, with a common tappet being assigned to the plurality of gripping devices of the particular gripper, which common tappet performs a linear actuating movement or a further linear actuating movement with the result that the clamping forces applied up to then onto the particular beverage can by the plurality of gripping devices in order to hold the particular beverage can are undone simultaneously or at least approximately simultaneously.

It is conceivable that the at least one tappet or the common tappet forms a thread, which communicates with a corresponding mating thread of the particular gripper, and with the at least one tappet or the common tappet being rotated preferably about its longitudinal axis and hereby performing a particular linear actuating movement. Alternatively or additionally, it is possible that the at least one tappet is pneumatically controllable to perform a particular linear actuating movement.

It is possible that the at least one gripper has at least one torsion spring, with which at least one torsion spring the at least one gripping device is in contact, with the at least one gripping device snapping under the top seam of a particular beverage can when receiving a particular beverage can, and with the form-fitting grip by the at least one gripping device being subsequently undone by a spring-elastic movement of the at least one gripping device against a spring force of the at least one torsion spring.

It is further possible that the at least one gripper has at least one ball joint, by which ball joint the particular at least one gripping device and/or the particular at least one centering device and/or the particular at least one tappet or the particular common tappet swivels, as required, if an actual position of a particular beverage can deviates from an expected target position of a particular beverage can when being received by the particular at least one gripper.

It is also conceivable that the at least one gripper comprises at least one spring, which at least one spring is preferably formed by a plurality of leaf springs, and which at least one spring swivels the particular at least one gripping device and/or the particular at least one centering device and/or the particular at least one tappet or the common tappet back with spring force into a starting position in a swivel movement performed after the particular at least one beverage can has been received.

### BRIEF DESCRIPTION OF THE FIGURES

In the following passages, the attached figures further illustrate typical embodiments of the invention and their advantages. The size ratios of the individual elements in the figures do not necessarily reflect the real size ratios. It is to be understood that in some instances various aspects of the invention may be shown exaggerated or enlarged in relation to other elements in order to facilitate an understanding of the invention.

FIGS. 1A and 1B show a schematic perspective view and a schematic section through an embodiment of a gripper according to the invention.

FIG. 2 shows individual details of the embodiment of a gripper according to FIGS. 1A and 1B.

FIGS. 3A and 3B illustrate a beverage can being received by the embodiment of a gripper according to FIGS. 1 and 2.

FIG. 4 shows a sectional view through a further embodiment of a gripper according to the invention.

FIG. 5 shows a further sectional view through the embodiment of a gripper according to FIG. 4.

FIG. 6 shows a total of five schematic illustrations (FIG. 6A, FIG. 6B, FIG. 6C, FIG. 6D, and FIG. 6E) presenting a further embodiment of a gripper according to the invention.

FIG. 7 shows a total of five schematic illustrations (FIG. 7A, FIG. 7B, FIG. 7C, FIG. 7D, and FIG. 7E) presenting a further embodiment of a gripper according to the invention.

FIG. 8 shows a schematic perspective view of an embodiment of a gripper head according to the invention.

FIG. 9 shows a total of four schematic perspective, side, or sectional views (FIG. 9A, FIG. 9B, FIG. 9C, and FIG. 9D) illustrating an embodiment of a gripping element comprising a plurality of grippers according to one embodiment of the present invention.

FIG. 10 shows a schematic view of a beverage can such as can be received in each instance by the embodiments of a gripper or a gripper head according to FIGS. 1 to 9.

FIG. 11 shows a flowchart of individual steps such as can be provided in various embodiments of the method according to the invention.

The same or equivalent elements of the invention are designated using identical reference characters. Furthermore, and for the sake of clarity, only the reference characters relevant for describing the individual figures are provided. It should be understood that the detailed description and specific examples, while indicating preferred embodiments, are intended for purposes of illustration only and are not intended to limit the scope of the invention.

### DETAILED DESCRIPTION OF THE INVENTION

It should be explicitly mentioned at this point that all aspects and embodiment variants explained in the context of the gripper and the gripper head according to the invention can likewise pertain to or constitute partial aspects of the method according to the invention. If specific aspects and/or interrelations and/or effects relating to the gripper or to the gripper head according to the invention are referred to at some point in the present description or in the claims definitions, this therefore likewise pertains to the method according to the invention. The same applies conversely, so that all aspects and embodiment variants explained in the context of the method according to the invention can likewise pertain to or constitute partial aspects of the gripper or the gripper head according to the invention. If specific aspects and/or interrelations and/or effects relating to the method according to the invention are referred to at some point in the present description or in the claims definitions, this therefore likewise pertains to the gripper or to the gripper head according to the invention.

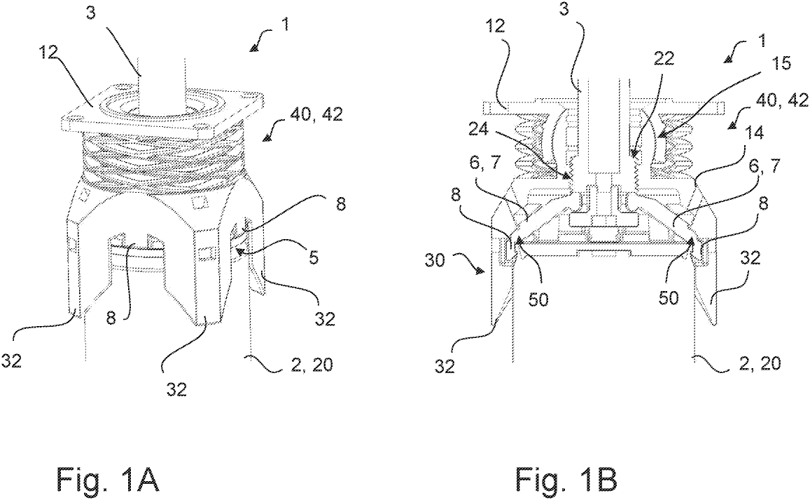

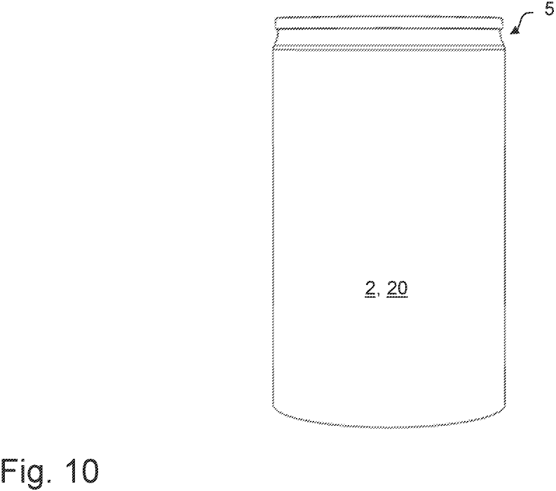

FIG. 1A shows a schematic perspective view and FIG. 1B shows a schematic section through an embodiment of a gripper 1 according to the invention. By the gripper 1 shown here, it is possible to receive a particular beverage can 20 such as the one exemplarily illustrated in FIG. 10. In order to achieve this, the gripper 1 comprises a plurality of gripping devices 6, which in the present context are each formed by a lever 7 and have a hook 8 at their downward facing end.

A centering device 30, which in the present context has four centering fingers 32, is arranged by a ball joint 15 (cf. FIG. 1B) at a mounting plate 12 of the gripper 1. In order to be able to receive a beverage can 20, the gripper 1 is positioned on the particular beverage can 20 in a direction coming from above. In this context, the four centering fingers 32 first come into abutment with an outer body surface 2 of the beverage can 20. If the beverage can 20 is not in an expected target position at this point, the beverage can 20 is shifted by the centering fingers 32 and brought into a suitable position in order to receive the beverage can 20 by the gripping devices 6 or by the hooks 8.

The gripper 1 is thus able to align the beverage can 20 by the centering device 30. In the perspective illustration of FIG. 1A, the beverage can 20 has not been received by the gripper 1 yet. Starting from the position of FIG. 1A, the gripper 1 has been moved further downward or further toward the beverage can 20, with the hooks 8, which are formed by the gripping devices 6, gripping the beverage can 20 from underneath the top seam in the region of its top seam 5 and then holding the beverage can 20 in a form-fitting manner, according to FIG. 1B.

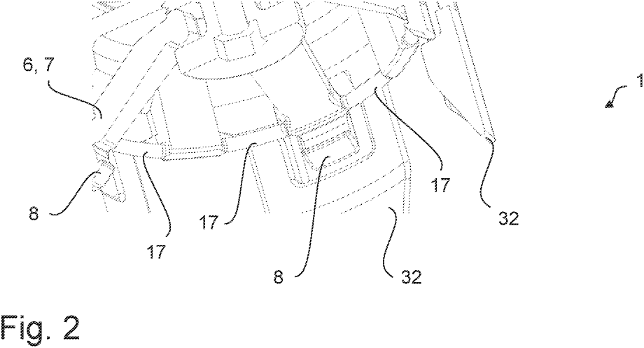

As will be described below for FIG. 2, the gripping devices 6 are in each instance in contact with a torsion spring 17 such that the hook 8 of the gripping devices 6 is able to be rotated about the pivot point 50 when the gripper 1 is being positioned onto the beverage can 20, and the hook 8 then snaps into the top seam 5 due to the restoring force of the torsion spring 17 and grips the beverage can 20 from underneath the top seam in a form-fitting manner in the region of the top seam 5, as is discernible in FIG. 1B.

The embodiment of the gripper 1 according to FIGS. 1A and 1B has exactly four gripping devices 6, which each have a hook 8 at their downward facing end. This number is merely to be understood as an example; other embodiments of a gripper 1 can also have more than exactly four gripping devices 6 or fewer than exactly four gripping devices 6.

If required, it is also possible for the arrangement or the displacement, by which the gripping devices 6 are offset about the longitudinal axis of the particular beverage can to be received, to differ from the arrangement or the displacement of the embodiment of FIGS. 1A and 1B.

In the present context, the gripping devices 6 or the hooks 8 are arranged offset relative to each other by 90°, whereby it is possible to hold the beverage can 20 in a very steady manner. FIG. 1B here also shows that the centering fingers 32 remain in surface contact with the outer body surface 2 of the beverage can 20 while the seam 5 of the beverage can 20 is being gripped from underneath the top seam by the gripping devices 6 or by the hook 8.

In addition to the function of the centering fingers 32 aligning the beverage can 20 in order for it to be received by the gripping devices 6, the beverage can 20 is held in its position under surface contact of its outer body surface 2 with the centering fingers 32 when the gripper 1 transports the particular received beverage can 20 or conveys it along a specified transfer path.

It is also clear from the perspective view of FIG. 1A that each centering finger 32 is followed by a hook 8 along the circumference of the beverage can 20. A hook 8 or a gripping device 6 is thus formed by the gripper 1 between each two centering fingers 32.

If the beverage can 20 is to be released after being handled by the gripper 1, it is necessary for this purpose for the grip of the beverage can 20 from underneath the top seam in the region of the top seam 5 by the hooks 8 to be undone. The hooks 8 or the gripping devices 6 thus have to be moved out of the seam 5 in each instance such that the beverage can 20 is hereupon no longer seized by the gripping devices 6 in a form-fitting manner. For this purpose, the gripper 1 has a tappet 3, which is able to perform a linear actuating movement in order to release the existing grip by the hooks 8.

The longitudinal section of FIG. 1B in this context illustrates that the tappet 3 forms a thread 22, which is in engagement with a corresponding mating thread 24 of the gripper 1. Due to the corresponding engagement between thread 22 and mating thread 24, the tappet 3, upon being rotated, moves either upward in a vertical direction or downward in a vertical direction in a linear manner and in dependence on the particular direction of rotation.

All gripping devices 6 are held by the tappet 3 or accommodated by the tappet 3 such that all hooks 8 may be moved out of the top seam 5 of the beverage can 20 by a single linear actuating movement of the tappet 3. The gripping devices 6 are rotated about the pivot point 50 by a linear downward actuating movement of the tappet 3 such that the hooks 8 leave the top seam 5 of the beverage can 20, with the result that the beverage can 20 is no longer held by the gripping devices 6 in a form-fitting manner. The gripping devices 6 or the lever 7 are thus reversibly elastically deformable, with the result that it is possible for the gripping devices 6 or the hooks 8 to be rotated about the pivot point 50.

As already mentioned above, the gripping devices 6 are in contact with the torsion springs 17, which are discernible in detail in the enlarged perspective illustration of FIG. 2. If the tappet 3 is moved back upward in a linear manner after a particular beverage can 20 has been released, the torsion springs 17 in the process swivel the gripping devices 6 or the hooks 8 back into a starting position, from which starting position the gripping devices 6 or the hooks 8 are able to snap under the top seam 5 of a particular further beverage can 20 when the gripper 1 is positioned onto the particular further beverage can 20.

In practice, it may be possible that beverage cans 20 of a relatively high mass have to be seized. In this case it is possible that the grip, which is exerted on such a beverage can 20 from underneath the top seam in a form-fitting manner in the region of its top seam 5, and a clamping force between a particular hook 8 and the beverage can 20, which clamping force is applied, as the case may be, by the torsion springs 17 (cf. FIG. 2) onto the hooks 8, are not sufficient to securely hold such a high-mass beverage can 20. The described functional principle of the gripper 1 advantageously also makes it possible to further intensify a clamping force applied by the hooks 8 in order to hold the beverage can 20.

As is discernible in FIG. 1B, the gripping devices 6 or the levers 7 are thus accommodated by the tappet 3 or mounted in the tappet 2 in a form-fitting manner. When the tappet 3 is moved upward in a linear manner, the gripping devices 6 necessarily rotates about the pivot point 50 in the process, with the result that a clamping force of the particular hook 8 pressing against the beverage can 20 is further intensified.

In many cases, however, a grip of a particular beverage can 20 from underneath the top seam in a form-fitting manner in the region of the top seam 5 will be sufficient to safely transport the beverage can 20 by the gripper 1. It is possible to additionally intensify the clamping force, as required, if a beverage can 20 has a relatively high mass.

If a beverage can 20 is not located in exactly the intended position for being received, a particular beverage can 20 is aligned by the centering fingers 32, as already described above, in order for the gripping devices 6 to be able to reliably receive the particular beverage can 20. In order to avoid damaging the beverage can 20 in the process, a first possibility that has proved successful is for the centering fingers 32 to taper downward according to FIGS. 1A and 1B. Since the centering fingers 32 themselves are formed to be rigid or relatively rigid, it has also proved successful, in addition or alternatively to the tapering design of the centering fingers 32, to provide a ball joint 15 and at least one spring 40. In the present context, the at least one spring 40 is formed by a plurality of leaf springs 42.

The longitudinal section of FIG. 1B furthermore shows that the ball joint 15 is formed by the mounting plate 12 and a formed part 14. The formed part 14 moreover forms the centering device 30 or it forms the centering fingers 32 and also the mating thread 24, which is in engagement with the corresponding thread 22 of the tappet 3.

If a centering finger 32 comes into contact with a beverage can 20 that is not in a suitable position to be received, it is possible for the centering fingers 32 to be swiveled by the ball joint 15 against the restoring force of the at least one spring 40 or of the leaf springs 42. After the beverage can 20 has been received or during the transport of the beverage can 20 by the gripper 1, the centering fingers 32 are swiveled back into a starting position by the restoring force of the at least one spring 40 or of the leaf springs 42. The at least one spring 40 or the leaf springs 42 are in mechanical contact with both the mounting plate 12 and the formed part 14 or are arranged between the formed part 14 and the mounting plate 12.

The perspective detailed view of FIG. 2 shows individual details of the embodiment of a gripper 1 according to FIGS. 1A and 1B. The torsion springs 17, with which the gripping devices 6 or the levers 7 are in contact, are discernible now in the illustration of FIG. 2. According to FIG. 2, it is possible in this context that a plurality of torsion springs 17 are provided, with adjacent gripping devices 6 being in each instance connected by an intermediately arranged torsion spring 17.

Alternatively, it is also conceivable that exactly one torsion spring 17 is provided, which has a circular and/or annular shape and with which each of all the gripping devices 6 are connected.

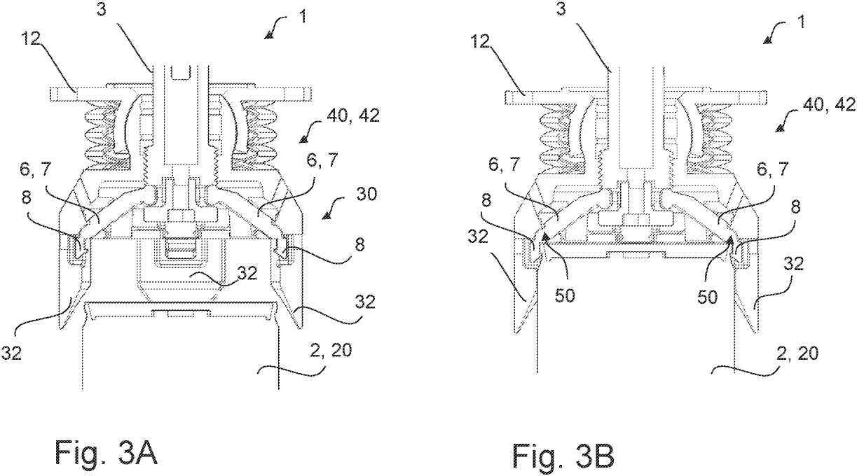

The two longitudinal section views of FIGS. 3A and 3B illustrate a beverage can 20 being received by the embodiment of a gripper 1 according to FIGS. 1 and 2. FIG. 3A shows the gripper 1 still arranged above the beverage can 20. It is possible for the gripper 1 to be coupled by the mounting plate 12 to a handling device, which is not illustrated here, and which moves the gripper 1 into the position according to FIG. 3A. It is also possible that the beverage can 20 is located on a horizontal conveyor. The handling device may be designed as an industrial robot or as a gantry system.

The FIGS. 3A and 3B seen in conjunction illustrate the further procedure of a beverage can 20 being received. The gripper 1 is positioned on the beverage can 20 in a direction coming from above, in which context the centering fingers 32 come into surface contact with an outer body surface 2 of the beverage can 20 and align the beverage can 20, as required, if the particular position of the beverage can 20 does not correspond to a target position that is suitable for the beverage can 20 to be received. During a further movement of the gripper 1 toward the beverage can 20, the hooks 8 snap into the top seam 5, whereby the beverage can 20 is gripped from underneath the top seam in a form-fitting manner and is secured to the gripper 1.

If required, it is possible to subsequently move the tappet 3 upward in a linear manner, whereby a clamping force of the hooks 8 gripping the beverage can 20 in the region of the top seam 5 is additionally intensified.

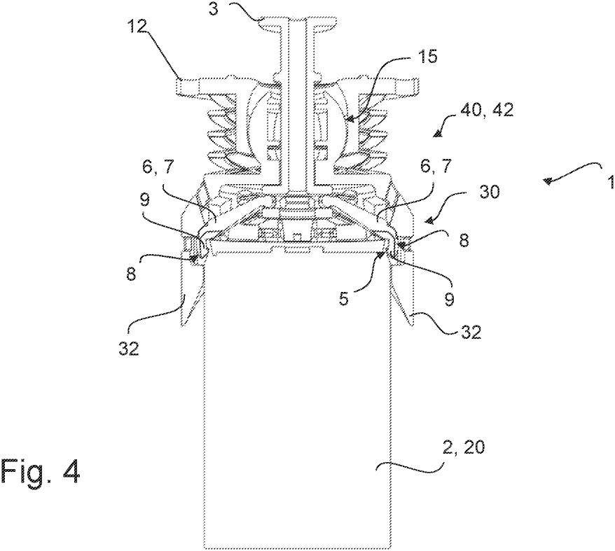

FIG. 4 shows a sectional view through a further embodiment of a gripper 1 according to the invention. Corresponding to the embodiment described above for the FIGS. 1 to 3, the embodiment of a gripper 1 according to FIG. 4 also comprises a tappet 3, a mounting plate 12, a formed part 14, at least one spring 40, which is made of leaf springs 42 in the present instance, a plurality of gripping devices 6 or levers 7, as well as a centering device 30 with a plurality of centering fingers 32, which are able to align a beverage can 20, as required, and to stabilize it while it is being handled.

In the embodiment of FIG. 4, the tappet 3 is actuated pneumatically, and it is able to perform a linear actuating movement with a particular pneumatic actuation, whereupon the hooks 8 are able to leave the top seam 5 of the beverage can 20, with the result that the beverage can 20 is released. Since in practice beverage cans 20 are gripped and transported by a gripper 1 at a high turnover, the gripping devices 6 frequently tend to show signs of wear in the region of their hooks 8.

In the embodiment of FIG. 4, the hooks 8 of the gripping devices 6 are each formed by an insert 9, which particular insert 9 can be replaced, as required, when signs of wear occur. It has proved successful for the inserts 9 to be made of steel, aluminum and/or plastic.

By the inserts 9 being replaceable, it is possible to ensure that even with wear occurring to a hook 8, a particular beverage can 20 will still be gripped from underneath the top seam in a form-fitting manner in the region of its top seam 5, and it will still be transported safely. It is not immediately necessary to replace the gripper 1, which thus has a long life.

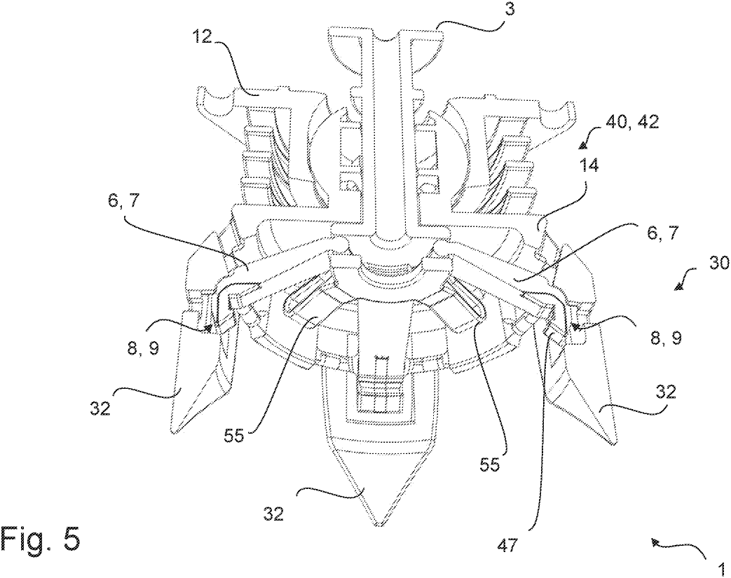

FIG. 5 shows a further sectional view through the embodiment of a gripper 1 according to FIG. 4. The inserts 9 are again discernible in FIG. 5, with the inserts 9 forming the hooks 8 of the gripping devices 6 and being able to grip a particular beverage can 20 from underneath the top seam in the region of its top seam 5 (cf. FIG. 10). The inserts 9 are accommodated in a form-fitting manner by a remaining part of the particular gripping device 6, and they can be extracted from the remaining part of the particular gripping device 6 by axial movement.

The embodiment of a gripper 1 according to FIGS. 4 and 5 moreover comprises a plurality of return springs 55 in contact with the tappet 3. Temporally after the tappet 3 has been moved in vertical direction downward in order for the grip of the hooks 8 from underneath the top seam in the region of the top seam 5 to be undone, the return springs 55 are able to move the tappet 3 in a linear manner back into a starting position by spring force.

Since the gripping devices 6 are in contact with the tappet 3, and since the return springs 55 press the tappet 3 with spring force upward in a linear manner, it is possible for the hooks 8, with a beverage can 20 having been received, to be moreover pressed by force application against the particular beverage can 20 by the return springs 55. A particular beverage can 20 is thus held in a clamping manner by the hooks 8 by a particular spring force of the return springs 55, whereby it is possible for the gripper 1 to transport a particular beverage can 20 with no risk or with merely a slight risk of becoming inadvertently disengaged.

The return springs 55 according to the embodiment of FIGS. 4 and 5, as well as the inserts 9 designed as hooks 8 according to the embodiment of FIGS. 4 and 5, may also be provided for the embodiment of FIGS. 1 to 3.

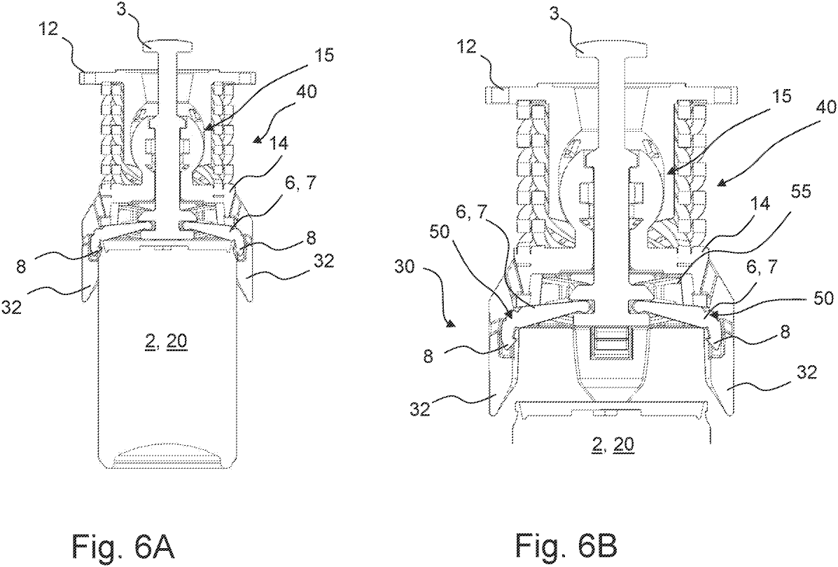

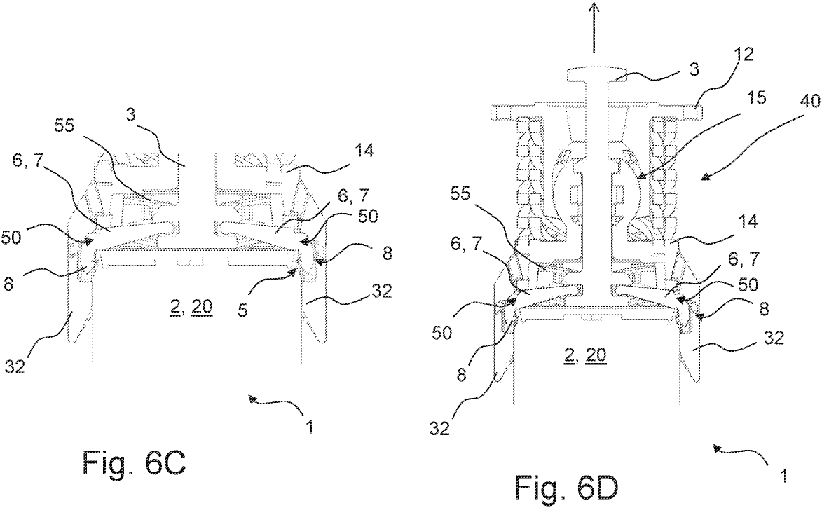

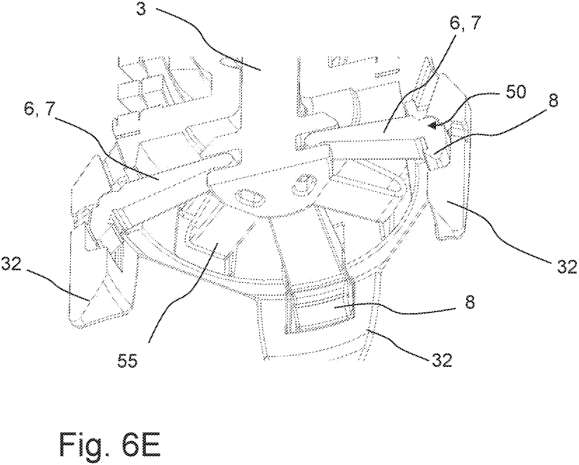

FIGS. 6A to 6E show a further embodiment of a gripper 1 according to the invention in a plurality of schematic illustrations. Corresponding to the embodiments described above for the FIGS. 1 to 5, the embodiment of a gripper 1 according to FIGS. 6A to 6E also comprises a tappet 3, a mounting plate 12, a formed part 14, at least one spring 40, a plurality of gripping devices 6 or levers 7, as well as a centering device 30 with a plurality of centering fingers 32, which are able to align a beverage can 20, as required, and to stabilize it while it is being handled.

The beverage can in the illustration of FIG. 6A is referred to with the reference number 20. The spring 40 is located on the outside or is accessible from the outside, and it applies a restoring force to the formed part 14 relative to the mounting plate 12 when the formed part 14 and the mounting plate 12 are swiveled relative to each other or are moved in axial direction relative to each other. It is possible to carry out such a swiveling when the centering fingers 32 are not precisely in line with the particular beverage can 20 during a positioning on the beverage can 20. In the process, the gripper 1 is able to carry out a compensatory movement by the ball joint 15.

The individual details of the embodiment of the gripper 1 are clearly discernible in the enlarged and detailed view of FIG. 6B. The tappet 3 has accommodated the gripping devices 6 according to the embodiments illustrated above and is able to swivel the hooks 8 by an axial movement about the pivot point 50.

The embodiment of a gripper 1 according to FIG. 6 also has a return spring 55, the function of which, however, differs in the embodiment of FIG. 6 from the above illustrated embodiments. For one thing, it is discernible from FIG. 6B seen in conjunction with FIG. 6C that the gripper 1 is being positioned onto a beverage can 20 in order to receive the particular beverage can 20. In this context, the centering fingers 32 align the beverage can 20 such that the gripping devices 6 are able to grip the beverage can 20 underneath the top seam 5 (cf. FIG. 6C) after the completed alignment of the beverage can 20.

The contact between the formed part 14 and the mounting plate 12 via the ball joint 15 is now formed such that it is possible to shift the formed part 14 in axial direction relative to the mounting plate 12 against a force of the spring 40. It is hereby possible to first compensate for tolerances in vertical direction when receiving the beverage can 20 if the height of the beverage can 20 slightly deviates from the expected target height. The formed part 14 can yield in vertical direction relative to the mounting plate 12. While the gripper 1 lifts up the beverage can 20 after having received it, the spring 40 guides the formed part 14 back into the starting position.

In practice, the gripper 1 is normally positioned onto the beverage can 20 such that the formed part 14 is moved in axial direction relative to the mounting plate 12 against the force of the spring 40. If the beverage can 20 is in a skewed position or if the beverage can 20 is not exactly in an expected position or not exactly in an expected orientation, it is possible to align the beverage can 20 by pushing it in such a manner by the centering fingers 32.

In the illustration of FIG. 6B, the gripper 1 is still arranged above the beverage can 20, whereas the gripper 1 in the illustration of FIG. 6C has already been positioned on the beverage can 20. After the gripper 1 has been positioned on the beverage can 20 according to FIG. 6C, the hook 8 is already located in the seam 5 or is at least arranged in a vicinity of the seam 5.

The beverage can 20 in FIG. 6C, however, is not yet being held securely by the gripper 1, as the hooks 8 are not yet pressed against the beverage can 20 with the specified clamping force. The return spring 55 in FIG. 6C is not loaded, or it merely applies a very weak spring force to the gripping devices 6. The further procedure for receiving the beverage can 20 follows from the consideration of the schematic illustration of FIG. 6D.

The tappet 3 is pulled in axial direction upward, whereby the hooks 8 press against the beverage can 20 in the seam 5 by force application or in a clamping manner and secure the beverage can 20 to the gripper 1. At the same time, the return spring 55 is loaded by the axial movement of the tappet 3 and is held in a loaded state. Starting from the illustration of FIG. 6D or after the beverage can 20 has been received, it is possible for the gripper 1 to move the beverage can 20 to a specified target location.

If the beverage can 20 is to be released at the target location, the tappet 3 is moved back for this purpose into the starting position in an axial manner by the restoring force of the return spring 55 and due to its mass, with the result that the beverage can 20 is no longer fixedly held to the gripper 1 by the hooks 8. The release of a beverage can 20 is thus performed without the help of an actuator and merely by the restoring force of the return spring 55 and due to the own weight or mass of the tappet 3.

FIG. 6E shows a schematic sectional view from diagonally below onto the gripper 1, now without the beverage can 20. The illustration of FIG. 6E in this context once again presents the constructional design of the return spring 55 for the embodiment described in FIGS. 6A to 6D. The return spring 55 consists of a plurality of V-shaped wings, more precisely, in the present case of four V-shaped wings, which are each fixedly connected at one end to the tappet 3.

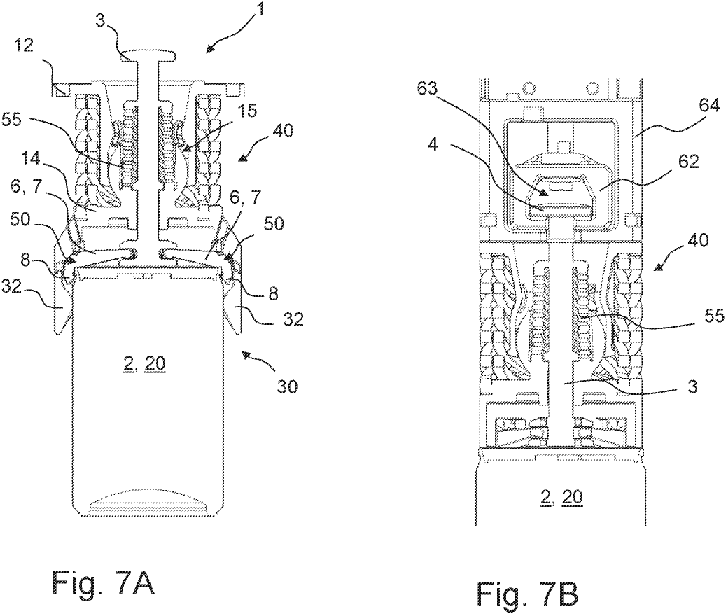

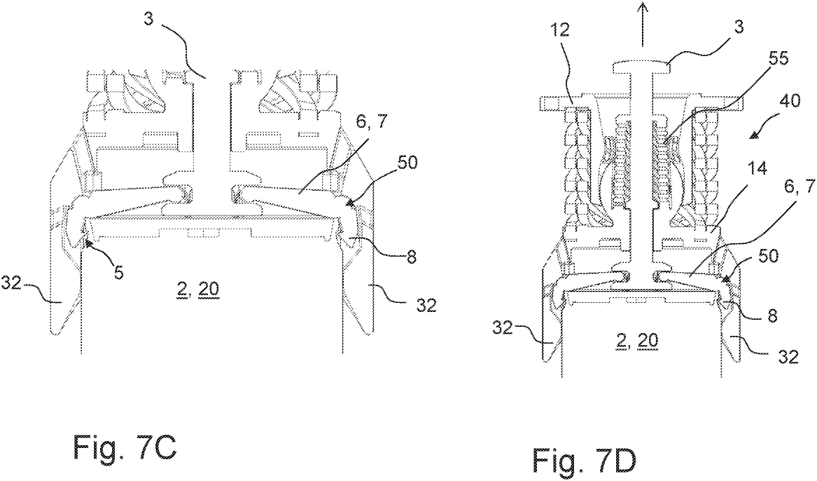

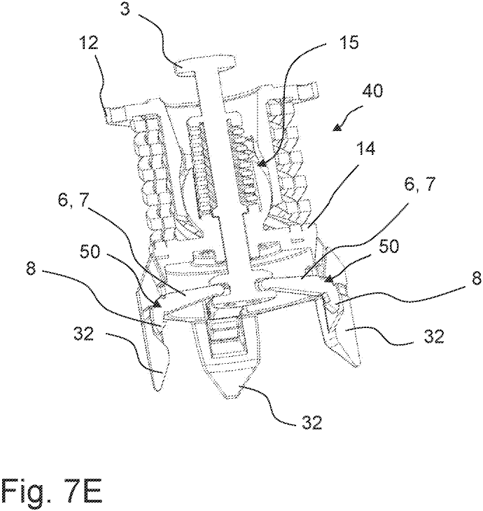

FIGS. 7A to 7E show schematic illustrations of a further embodiment of a gripper 1 according to the invention. Corresponding to the embodiments described above for the FIGS. 1 to 6, the embodiment of a gripper 1 according to FIG. 7 also comprises a tappet 3, a mounting plate 12, a formed part 14, at least one spring 40, a plurality of gripping devices 6 or levers 7, as well as a centering device 30 with a plurality of centering fingers 32, which are able to align a beverage can 20, as required, and to stabilize it while it is being handled.

The beverage can in the illustration of FIG. 7A is furthermore referred to with the reference number 20. The spring 40 is located on the outside or is accessible from the outside, and it applies a restoring force to the formed part 14 relative to the mounting plate 12 when the formed part 14 and the mounting part 12 are swiveled relative to each other or are moved in axial direction relative to each other. It is possible to carry out such a swiveling when the centering fingers 32 are not precisely in line with the particular beverage can 20 during a positioning on the beverage can 20. In the process, the gripper 1 is able to carry out a compensatory movement by the ball joint 15.

The embodiment of a gripper 1 of FIGS. 7A to 7E differs from the embodiment of a gripper 1 of FIGS. 6A to 6E in the constructional design of the return spring 55. In accordance with the embodiment of the return spring 55 of FIG. 6A and the following, the return spring 55 of the embodiment of FIG. 7A and the following is provided for the purpose of moving the tappet 3 back into a starting position by spring force if a beverage can 20 is to be released by the gripper 1.

The embodiment of a return spring 55 according to FIGS. 7A to 7E is positioned in the region of the ball joint 15. The tappet 3 extends through the return spring 55. The return spring 55 is furthermore fixedly connected to the mounting plate 12 of the gripper 1. Such a design of a return spring 55 as is shown in the embodiment according to FIGS. 7A to 7E is characterized by a high fatigue strength.

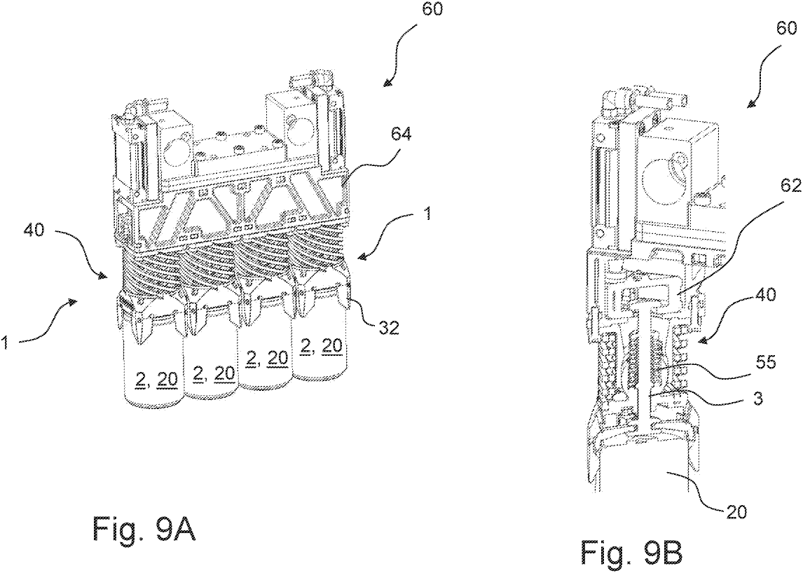

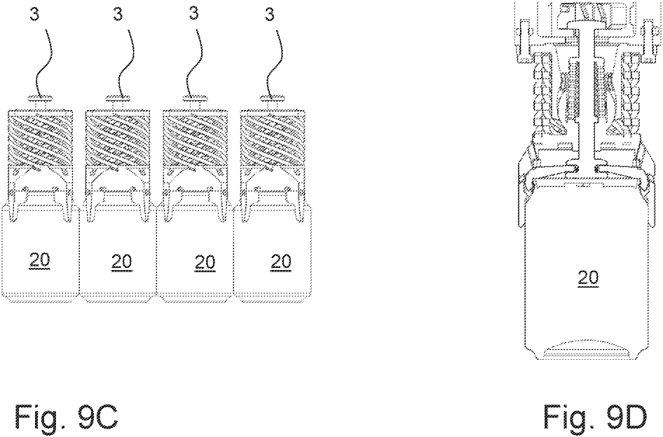

In addition to the gripper 1 according to FIG. 7A, the detailed schematic illustration of FIG. 7B shows a mechanism by which the tappet 3 may be actuated to receive a beverage can 20. The mechanism is a part of the entire gripping element 60 that is discernible in the schematic perspective view according to FIG. 9A.

As shown in FIG. 7B, the tappet 3 forms a head 4 with a mushroom-shaped design at its upward facing end. An actuator 62 grips the head 4 from underneath such that the actuator 62 can be moved upward, and it hereby pulls the tappet 3 upward along with it. As described above, it is hereby possible to bring the hooks 8 into abutment with the beverage can 20 in the region of the seam 5 by force application.

If a particular beverage can 20 is to be released, the actuator 62 is moved back downward into the starting position according to FIG. 7B. In this context, the tappet 3 follows the movement of the actuator 62 and is moved downward due to the restoring force of the return spring 55 and due to its own mass or its own weight.

The longitudinal section of FIG. 7B moreover shows that the actuator 62 is accommodated in a casing 64, which, on the one hand, guides the actuator 62 in axial direction and, on the other hand, prevents an unintentional access by a user from outside. FIG. 7B also illustrates that the actuator 62 has a free space 63 where the head 4 of the tappet 3 is accommodated. The head 4 can be lifted in axial direction relative to the actuator 62 within this free space 63. If the gripper 1 does not come precisely in line with a beverage can 20 when being positioned on the particular beverage can 20, the tappet 3 is able to yield upward slightly, whereby a damage to the particular beverage can 20 is counteracted.

In practice, it is furthermore provided that the gripper 1 is positioned on the beverage can 20 and is subsequently moved further toward the beverage can 20, or is subsequently pressed onto the beverage can 20 until the formed part 14 and the mounting plate 12 advance toward each other. Such a relative movement between formed part 14 and mounting plate 12 can be 2 millimeters, as the case may be. If the beverage can 20 is not in a target position or if it is in an orientation deviating from a target orientation it is possible for the beverage can 20 to become aligned by being pushed in such a manner. In this context, the tappet is again able to yield into the free space 63 such that the pushing in practice will not involve a damage to the beverage can 20.

The FIGS. 7C and 7D seen in conjunction once more illustrate two consecutive steps as are carried out when a beverage can 20 is received by the embodiment of a gripper 1 according to FIG. 7.

In FIG. 7C, the gripper 1 is already positioned on the beverage can 20. The hooks 8 are already in the region of the seam 5, but have not yet been brought into abutment by force application with the beverage can 20.

In FIG. 7D, the tappet 3 is pulled upward, whereby the hooks 8 come into abutment with the beverage can 20 by force application and whereby the return spring 55 is simultaneously loaded. If the beverage can 20 is to be disengaged from the gripper 1, the tappet 3 is moved back into its starting position by the restoring force of the the return spring 55.

FIG. 7E shows a schematic sectional view through the gripper 1 and in this context shows, in particular, the design of the embodiment of a return spring 55 that is designed as a part of the gripper 1. The return spring 55 is positioned in the region of the ball joint 15. The return spring 55 is moreover guided around the tappet 3, or it accommodates the tappet 3. At its top end, the tappet 3 forms a head 4 with a mushroom-shaped design that can thus be gripped from underneath by an actuator 62 according to FIG. 7B.

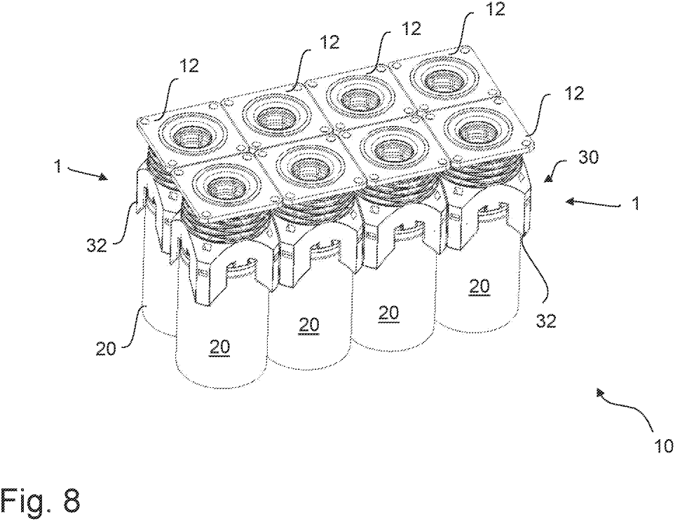

FIG. 8 shows a schematic perspective view of an embodiment of a gripper head 10 according to the invention. The gripper head 10 comprises a multitude of grippers 1, which can be designed according to the exemplary embodiment of FIGS. 1 to 3 and/or according to the exemplary embodiment of FIGS. 4 and 5.

The beverage cans 20 received by the gripper head 10 in FIG. 8 and illustrated again in FIG. 10 are designed as so-called slimline cans, and they are characterized in that a cross-sectional diameter of the beverage can 20 is formed to be identical nearly along its entire height. Such a beverage can 20 merely has a necking in the region of the seam 5. A top edge region and the outer body surface 2 of the beverage can 20 have an identical or nearly identical cross-sectional diameter.

When a group of such beverage cans 20 is received, adjacent beverage cans 20 are in abutment with each other via their outer body surfaces 2. Gripper heads known from the prior art receive such groups of beverage cans 20 in a pneumatic manner, for which purpose a negative pressure is produced in each instance between a lid of a particular beverage can and the gripper head. In this context, the beverage can 20 dips into a particular suction head of such a gripper head.

Due to the geometry of a slimline can as exemplarily illustrated in FIG. 10, such a gripper head cannot, or only with problems, receive a plurality of contiguous beverage cans 20 in a pneumatic manner, because due to their geometry, the beverage cans 20 are very close to each other from the bottom section up to the lid. With gripper heads known from the prior art, it is not possible for contiguous slimline cans to be dipped into the particular suction head in order for the gripper to thus be able to seize these beverage cans in a pneumatic manner.

A further disadvantage lies therein that a particular beverage can 20 may inadvertently become disengaged from the suction head, because the lid does not have an even surface due to the pull tab being arranged in the lid. It is also not possible with the gripper heads known from the prior art to receive a plurality of such beverage cans 20 in a mechanical manner by clamping abutment of gripping elements on the outer body surfaces 2, because the beverage cans 20 are in abutment with each other nearly along their entire longitudinal extension due to their geometry, and the outer body surfaces 2 are therefore partly not accessible along their entire longitudinal extension.

The gripper head gripper head 10 of FIG. 8 is able to receive and subsequently safely transport a plurality of such beverage cans 20. From FIG. 8 it is discernible in this context that the centering fingers 32 are each positioned such that the centering fingers 32 are in surface contact with an outer body surface 2 of the particular beverage can 20 in a specific region, which specific region is offset along the circumference of the particular beverage can 20 relative to a contact region in which the particular beverage can 20 is contiguous to an adjacent beverage can 20. By such a positioning of the centering fingers 32, it is possible to align all beverage cans 20 of a particular group by the centering fingers 32 while the gripper 1 is being positioned onto the beverage cans 20.

During a further movement of the gripper 1 toward the beverage cans 20, the beverage cans 20 are gripped from underneath the top seam in a form-fitting manner in the region of their particular top seams 5 by a plurality of gripping devices 6, as already described above for the FIGS. 1 to 5. The gripper head 10 is therefore particularly suited to receive a plurality of beverage cans 20 standing in abutment with each other and being formed by slimline cans.

The different views of the FIGS. 9A to 9D show an exemplary embodiment of a gripping element 60 that is able to receive a plurality of beverage cans 20 simultaneously. The gripping element 60 has an own gripper 1 for each beverage can 20 to be received. The gripping element 60 in the present instance is able to seize four beverage cans 20 simultaneously, for which purpose the gripping element 60 has four grippers 1. In the gripping element 60 of FIGS. 9A to 9D, the grippers 1 are each designed according to the above-described exemplary embodiment of FIGS. 7A to 7E.

From FIG. 9A, the spring 40, or the spring 40 located on the outside, is discernible, which spring 40 provides for an appropriate tolerance compensation if a particular gripper 1 is not positioned precisely on the particular beverage can 20. Furthermore, shown in FIG. 9A with the reference number 64 and already illustrated in FIG. 7B, is the casing in which the actuator 62 are arranged, which are provided to axially move a particular tappet 3.

Each gripper 1 comprises four centering fingers 32, which are brought into abutment with an outer body surface 2 of a particular beverage can 20 in order to align the particular beverage can 20. According to the exemplary embodiment of FIG. 9, it is possible for a gripping element 60 to be mounted to a gantry system, for example, which guides the gripping element 60 above the beverage containers.

FIG. 9B again shows the actuator 62, which is able to pull the tappet 3 upward and hereby presses the hooks 8 against the beverage can 20 by force application or in a clamping manner. Again illustrated is also the return spring 55, which is able to move the tappet 3 back into the starting position in order for the beverage can 20 to be released.

The grippers 1 from the FIGS. 9C and 9D are identical to the grippers 1 from the FIGS. 9A and 9B, or they relate to an exemplary embodiment. From the FIGS. 9A and 9B seen in conjunction with FIGS. 9C and 9D, it is clear that the grippers 1 are suited to receive so-called slimline cans as are exemplarily illustrated in FIG. 10.

According to FIGS. 9C and 9D, it is also possible for these grippers 1 to receive other beverage cans 20 that are different in terms of their geometry from the slimline cans of FIG. 10. Such a gripper 1 is thus also suited to receive beverage cans 20 formed by customary beverage cans or standard cans, by preserved food cans or by beverage cans 20 with a polygonal cross section.

FIG. 10 shows a schematic view of a beverage can 20 such as can be received in each instance by the embodiments of a gripper 1 or a gripper head 10 and a gripping element 60 according to FIGS. 1 to 9. The beverage can 20 is designed as slimline can, with a cross-sectional diameter of the beverage can 20 remaining nearly constant along its entire height. Merely in the region of the lid or the pull tab does the beverage can 20 form a top seam 5, by which a gripper 1 or a gripper head 10 or a gripping element 60 is able to grip the beverage can 20 from underneath the top seam in a form-fitting manner, in accordance with the previous exemplary embodiments of FIGS. 1 to 9.

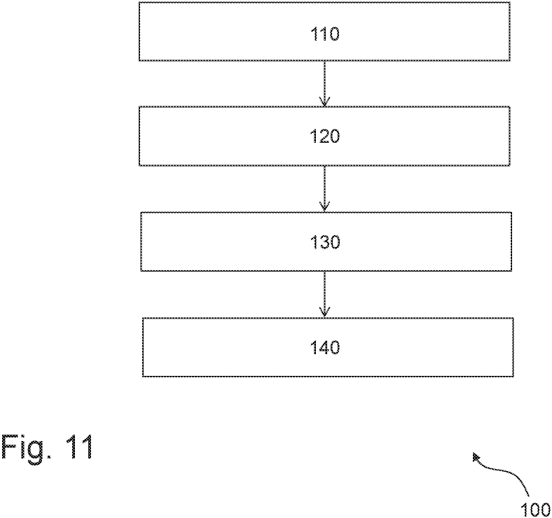

FIG. 11 shows a flowchart of individual steps such as can be provided in various embodiments of the method 100 according to the invention. In the first method step 110, a gripper 1 is lowered toward a beverage can 20, with the particular beverage can 20 being brought into a defined alignment by the centering device 30, which is designed as a part of the at least one gripper 1, in which defined alignment a plurality of gripping devices 6 designed as part of the gripper 1 are able to grip the beverage can 20 from underneath the top seam in a form-fitting manner in the region of a top seam 5. In order to bring the beverage can 20 into the defined alignment, a plurality of centering fingers 32 designed as part of the centering device 30 come into contact with an outer body surface 2 of the beverage can 20 and in the process push the particular beverage can 20 into the defined alignment.

In the second method step 120, the gripper 1 is lowered further toward the beverage can 20. Hereby, the particular beverage can 20 is gripped from underneath the top seam in a form-fitting manner in the region of its top seam 5, for which purpose a hook 8 of the gripper 1 snaps into the top seam 5 of the beverage can 20.

In the following third step 130, the beverage can 20 received by the gripper 1 is transported toward a further handling.

Subsequently, the fourth step 140 is carried out, in which the hooks 8 are moved out of the top seam 5 of the beverage can 20, and the beverage can 20 is thus no longer seized by the gripper 1, or rather, it is released. It is then possible for the gripper 1 to be moved toward a further beverage can 20 in order for the gripper 1 to receive the further beverage can 20.

The embodiments, examples, and alternatives of the preceding paragraphs, the claims, or the description and the figures, including any of their various aspects or respective individual features, may be taken independently or in any combination. Features described in connection with one embodiment are applicable to all embodiments, unless such features are incompatible.

If illustrations and aspects are generally referred to as being “schematic” in the context of the above description of figures, this is by no means intended to imply that the illustrations of the figures and their description are of inferior significance with regard to the disclosure of the invention. The person skilled in the art is fully capable of gathering sufficient information from the schematically and abstractly drawn illustrations for facilitating the understanding of the invention without the understanding being in any way impaired by any of the drawn elements or, for example, by the size ratios potentially not being drawn precisely true to scale. On the basis of the more concretely explained realizations of the method according to the invention and on the basis of the more concretely explained functionality of the gripper and of the gripper head according to the invention in the figures, the person skilled in the art as a reader is thus enabled to derive a better understanding of the inventive idea, which is formulated in a more general and/or more abstract manner in the claims and in the general part of the description.

List of Reference Numbers

| | |
|---|---|
| 1 | Gripper |
| 2 | Outer body surface |
| 3 | Tappet |
| 4 | Head |
| 5 | Seam |
| 6 | Gripping devices |
| 7 | Lever |
| 8 | Hook |
| 9 | Insert |
| 10 | Gripper head |
| 12 | Mountingplate |
| 14 | Formed part |
| 15 | Ball joint |
| 17 | Torsion spring |
| 20 | Beverage can |
| 22 | Thread |
| 24 | Mating thread |
| 30 | Centering device |
| 32 | Centering finger |
| 40 | Spring |
| 42 | Leaf spring |
| 50 | Pivot point |
| 55 | Return spring |
| 60 | Gripping element |
| 62 | Actuator |
| 63 | Free space |
| 64 | Casing |
| 100 | Method |
| 110 | First method step |
| 120 | Second method step |
| 130 | Third method step |
| 140 | Fourth method step |

1. A gripper (1) comprising:
at least one gripping device (6) used to grip a particular beverage can (20) from underneath a top seam (5), in a form-fitting manner, in a region of a top seam (5) of the particular beverage can (20), and
at least one centering device (30), wherein the at least one centering device (30) moves the particular beverage can (20) into a defined alignment, where the at least one gripping device (6) is capable of gripping the particular beverage can (20) from underneath the top seam (5) in a form-fitting manner in the region of the top seam (5) of the beverage can (20).

2. The gripper of claim 18, wherein the at least one tappet (3) interacts with the at least one gripping device (6) wherein the form-fitting grip of the at least one gripping device (6) te-can be undone by the linear actuating movement of the at least one tappet (3), or wherein the at least one tappet (3) interacts with the at least one gripping device (6) such that the at least one gripping device (6) is capable of applying a clamping force by the linear actuating movement of the at least one tappet (3).

3. The gripper of claim 18, wherein the common tappet (3) interacts with a plurality of gripping devices (6) where the form-fitting grip of the plurality of gripping devices (6) can be undone by the linear actuating movement of the common tappet (3), or wherein the common tappet (3) interacts with that the plurality of gripping devices (6) such that the plurality of gripping devices (6) are capable of applying a clamping force by the linear actuating movement of the common tappet (3).

4. The gripper of claim 18, wherein the at least one tappet (3) or the common tappet (3) comprises a thread (22), which communicates with a corresponding mating thread (24) such that the at least one tappet (3) or the common tappet (3) performs the linear actuating movement by a rotary movement about its longitudinal axis, or in wherein
the at least one tappet (3) or the common tappet (3) is pneumatically controllable to perform the linear actuating movement.

5. The gripper of claim 18, further comprising at least one return spring (55), wherein the at least one return spring (55):
is capable of applying spring force to the tappet (3) or the common tappet (3) in order to return it into a starting position after performing the linear actuating movement, or wherein
is capable of pressing the at least one gripping device (6) against the particular beverage can (20).

6. The gripper of claim 5, wherein the at least one gripping device (6) comprises at least one insert (9) wherein the at least one insert (9) is a replaceable part of the at least one gripping device (6).

7. The gripper of claim 6, further comprising at least one torsion spring (17) in contact with each of, the at least one gripping device (6), wherein the at least one gripping device (6) is held in its-position by the at least one torsion spring (17) while the gripping device (6) grips a particular beverage can (20), and wherein the form-fitting grip of the at least one gripping means (6) is undone by spring-elastic movement of the at least one gripping device (6) against the at least one torsion spring (17).

8. The gripper of claim 7, further comprising a ball joint (15), wherein the at least one gripping device (6) or the at least one centering device (30) or the at least one tappet (3) or the common tappet (3) are swivel-mounted.

9. The gripper of claim 8, further comprising at least one spring (40) and wherein the at least one spring (40) provides a restoring force in a swivel movement of the ball joint (15) for the at least one gripping means (6) or for the at least one centering device (30) or for the at least one tappet (3) or the common tappet (3).

10. A gripper head (10) for a plurality of beverage cans (20) comprising:
at least two grippers (1), wherein each of the at least two grippers (1): (a) grips a single beverage can (20) from a plurality of beverage cans (20), and (b) comprises at least one centering device (30) that comes into surface contact with at least one defined region of an outer body surface of a particular beverage at least one defined region is offset along the circumference of the particular beverage can (20) relative to at least one contact region a beverage can (20) with a contiguous at least one other beverage can (20).

11. A method (100) used to receive at least one beverage can (20) by at least one gripper (1), comprising:
aligning at least one beverage can (20) with at least one centering device (30), which is part of the at least one gripper (1); and
gripping, with at least one gripping device (6), which is a part of the at least one gripper (1), a particular beverage can (20) from underneath the top seam (5) in a form-fitting manner in the region of a top seam (5) of the particular beverage can (20).

12. The method of claim 20, wherein the at least one gripper (1) further comprises at least one tappet (3), wherein, when the at least one tappet (3) performs the linear actuating movement, (a) the form-fitting grip by the at least one gripping device (6) is undone, or (b) a clamping force applied onto a particular beverage can (20) by the at least one gripping device (6) is undone.

13. The method of claim 20, wherein the at least one gripper (1) each has a plurality of gripping device (6) and a common tappet (3), wherein, when the common tappet (3) performs the linear actuating movement, (a) the form-fitting grips by the plurality of gripping devices (6) are undone simultaneously or at least approximately simultaneously, or (b) the clamping forces applied onto the beverage cans (20) by the plurality of gripping devices (6) are undone simultaneously or at least approximately simultaneously.

14. The method of claim 20, wherein the at least one tappet (3) forms a thread (22), which communicates with a corresponding mating thread (24) of the at least one gripper (1), and wherein the at least one tappet (3) is rotated about its longitudinal axis to perform the linear actuating movement, or wherein
the at least one tappet (3) is pneumatically controlled to perform the linear actuating movement.

15. The method of 11, wherein the at least one gripper (1) further comprises at least one torsion spring (17), in contact with each of the at least one gripping devices (6),wherein the at least one gripping devices (6) closes under the top seam (5) of a particular beverage can (20), and wherein the form-fitting grip of the at least one gripping device (6) is undone by a spring-elastic movement of the at least one gripping device (6) against the at least one torsion spring (17).

16. The method of claim 15, wherein the at least one gripper (1) further comprises a ball joint (15), wherein the at least one gripping means (6) or the at least one centering device (30) or the particular at least one tappet (3) swivels if an actual position of a particular beverage can (20) deviates from an expected target position of a particular beverage can (20) when being received by the particular at least one gripper (1).

17. The method of claim 16, wherein the at least one gripper (1) further comprises at least one spring (40) wherein the at least one spring (40) swivels the particular at least one gripping device (6) or the particular at least one centering device (30) or the particular at least one tappet (3) with spring force into a starting position performed after the particular at least one beverage can (20) has been received.

18. The gripper of claim 1, further comprising at least one tapper (3) or further comprising a common tappet (3) capable of performing a linear actuating movement.

19. The gripper of claim 6 wherein the insert (9) comprises a hook (8).

20. The method of claim 11 wherein the at least one gripper (1) further comprises at least one tapper (3) or further comprising a common tappet (3) capable of performing a linear actuating movement.
